(19) United States
(12) Patent Application Publication
(10) Pub. No.: US 2026/0028156 A1
(43) Pub. Date: Jan. 29, 2026

(54) SELECTABLE DISCRETE-LENGTH ENVELOPES

(71) Applicant: Pregis LLC, Chicago, IL (US)

(72) Inventor: Thomas D. Wetsch, Naples, FL (US)

(21) Appl. No.: 19/281,097

(22) Filed: Jul. 25, 2025

Related U.S. Application Data
(60) Provisional application No. 63/675,700, filed on Jul. 25, 2024.

(51) Int. Cl. B65D 27/18; B31B 70/64; B31B 155/00

(52) U.S. Cl. CPC B65D 27/18; B31B 70/642; B31B 2155/002

(57) ABSTRACT

Webs for forming envelopes include a bonding element, such as a heat-activatable material, applied in closely-spaced strips that extend across at least one wall the web so that seals can be formed at selected locations along the web to allow the sizes of the envelopes to be varied.

### CROSS-REFERENCE TO RELATED APPLICATIONS

This application claims the benefit under 35 U.S.C. § 119 (e) of U.S. Provisional Patent Application No. 63/675,700, filed Jul. 25, 2024, the contents of which are incorporated by reference herein in their entirety.

### BACKGROUND

The use of shipping envelopes formed from paper has been growing in popularity in relation to poly bags, i.e., bags made of plastics such as polyethylene and polystyrene, due to the recyclability of paper. Poly bags typically are sealed closed after being loaded, by a heat seal formed by heating portions of opposing walls of the bag so that the wall portions fuse together. Sealing a paper envelope, by contrast, typically requires a separate bonding element in the form of an adhesive material deposited on one or both of the interior surfaces of the opposing walls.

In some applications, individual envelopes may be formed from a pre-formed web using automated equipment that also seals the envelope and separates the sealed envelope from the rest of the web after the envelope has been loaded. In such applications, the length of the envelope, i.e., the dimension of the envelope in the direction in which the envelope is advanced through the automated equipment, is set by the relative locations of the bonding elements on the interior surface or surfaces of the web. Thus, changing the length of the envelopes produced by the automated equipment requires that the web be changed out to another web specifically tailored to the desired length of the envelopes to be produced.

### SUMMARY OF THE INVENTION

In one aspect of the disclosed technology, an envelope for holding an item includes a first flexible wall, a second flexible wall overlying the first flexible wall and affixed to the first flexible wall about at least a portion of a pocket border. The pocket border encloses a pocket defined at least in part by the first and second flexible walls and configured and dimensioned to contain the item. At least one of the first and second flexible walls define a pocket opening allowing access to the pocket from an exterior of the envelope for loading the item into the pocket. The second flexible wall is affixed to the first flexible wall by a first and a second seal; and

The envelope also includes a first, a second, and a third strip of a bonding element each extending across the first flexible wall in substantially the same direction. The first seal is formed from the first strip, the second seal is formed from the second strip, and the third strip is located between the first and second strips and is un-affixed to the second flexible wall.

In another aspect of the disclosed technology, the first seal is located at a first end of the envelope, and the second seal is located at a second end of the envelope.

In another aspect of the disclosed technology, the first seal is located at a top of the envelope, and the second seal is located at a bottom of the envelope.

In another aspect of the disclosed technology, the bonding element is a heat-activatable material.

In another aspect of the disclosed technology, the third strip is un-activated.

In another aspect of the disclosed technology, the heat-activatable material is a heat-sealable material or a hot-melt adhesive.

In another aspect of the disclosed technology, the first, second, and third strips extend transversely across the first flexible wall.

In another aspect of the disclosed technology, the bonding element is further configured in a longitudinal fourth strip on the first flexible wall, and the second flexible wall is further affixed to the first flexible wall by a third seal formed from the fourth strip.

In another aspect of the disclosed technology, the first, the second, and the third seals define at least a portion of the pocket border.

In another aspect of the disclosed technology, the fourth strip adjoins the first, second, and third strips.

In another aspect of the disclosed technology, the first and second flexible walls are paper.

In another aspect of the disclosed technology, the bonding element is a first bonding element, the envelope further comprises a second bonding element configured in a plurality of strips each extending across the second flexible wall, and the first seal is further formed from a first of the strips on the second flexible wall. The second seal is further formed from a second of the strips on the second flexible wall, and a third one of the strips on the second flexible wall is located between the first and second strips on the second flexible wall.

In another aspect of the disclosed technology, the second seal is configured to seal the pocket opening closed after the item has been inserted into the pocket.

In another aspect of the disclosed technology, the first strip is spaced from the third strip by a first distance, and the second strip is spaced from the third strip by a second distance different than the first distance.

In another aspect of the disclosed technology, a method for forming an envelope configured to hold an item to be packaged includes providing a web having a first flexible wall, a second flexible wall overlying the first flexible wall and affixed to the first flexible wall about at least a portion of a pocket border that encloses a pocket defined between the first and second flexible walls and configured to contain the item, and a bonding element configured in a first, a second, and a third strip of the bonding element each extending across the first flexible wall.

The method also includes forming a first seal between the first and second flexible walls from the first strip using a sealing device, advancing the web to align the second strip with the sealing device, and forming a second seal between the first and second flexible walls from the second strip using the sealing device. Advancing the web to align the strip with the sealing device includes advancing the third strip past the sealing device without forming a seal from the third strip.

In another aspect of the disclosed technology, a method is provided for forming an envelope configured to hold an item to be packaged. The method includes providing a web having a first, a second, and a third strip of a bonding element extending across a first surface, the first surface forming a part of the web. The method also includes forming, from the first strip, a first seal between the first surface and an opposing second surface overlying the first surface, and advancing the web to align the second strip with a sealing device.

The method also includes forming, from the second strip, a second seal between the first and second surfaces. The first and second seals affix the first surface to the second surface about at least a portion of a pocket border. The pocket border encloses a pocket defined at least in part by the first and second surfaces and configured and dimensioned to contain the item. At least one of the first and second surfaces define a pocket opening allowing access to the pocket from an exterior of the envelope for loading the item into the pocket. Advancing the web to align the second strip with the sealing device includes advancing the third strip past the sealing device without forming a seal from the third strip.

In another aspect of the disclosed technology, advancing the web to align the strip with the sealing device further includes advancing the web by a distance about equal to a desired height or a desired length of the envelope.

In another aspect of the disclosed technology, the third strip is located between the first and second strips on the web.

In another aspect of the disclosed technology, the first, second, and third seals extend in a generally transverse direction of the web, and advancing the web to align the second strip with the sealing device further includes advancing the web in a lengthwise direction of the web.

In another aspect of the disclosed technology, the method further includes inserting the item to be packaged into the pocket after forming the first seal and before forming the second seal.

In another aspect of the disclosed technology, the method further includes separating the envelope from the web by forming a line of separation through the second seal.

In another aspect of the disclosed technology, the envelope is a first envelope, and advancing the web to align the second strip with the sealing device further includes advancing the web by a distance about equal to a desired height or a desired length of the first envelope. The method further includes advancing the web by a second distance after separating the envelope from the web. The second distance corresponds to a desired height or a desired length of a second envelope.

In another aspect of the disclosed technology, the second distance is unequal to the first distance.

In another aspect of the disclosed technology, the method further includes varying a distance by which the web is advanced to align the second strip with the sealing device to provide the envelope with a desired dimension in a lengthwise direction of the web.

In another aspect of the disclosed technology, advancing the web by a second distance after separating the envelope from the web includes advancing the web to align a fourth of the strips of the bonding element with the sealing device, and the method further includes forming a third seal between the first and second surfaces from the fourth strip of the bonding element using the sealing device.

In another aspect of the disclosed technology, the bonding element is a heat-activatable material, forming a first seal between the first and second surfaces from the first strip using a sealing device includes applying localized heat and pressure to the first strip, and forming a second seal between the first and second surfaces from the second strip using the sealing device includes applying localized heat and pressure to the second strip.

In another aspect of the disclosed technology, the method further includes inserting the item into the pocket by way of a pocket opening defined between the first and second surfaces, and forming a second seal between the first and includes sealing the pocket opening closed after the item has been inserted into the pocket.

In another aspect of the disclosed technology, the web is formed from paper.

In another aspect of the disclosed technology, a method for forming an envelope configured to hold an item to be packaged includes providing a web having a plurality of strips of a bonding element extending across a first surface, the first surface forming a part of the web, and forming, from a first of the strips of the bonding element, a first seal between the first surface and an opposing second surface overlying the first surface. The method also includes advancing the web to align the second of the strips of the bonding element with a sealing device, and forming, from the second strip, a second seal between the first and second surfaces. The first and second seals affix the first surface to the second surface about at least a portion of a pocket border. The pocket border encloses a pocket defined at least in part by the first and second surfaces and configured and dimensioned to contain the item. At least one of the first and second surfaces defines a pocket opening allowing access to the pocket from an exterior of the envelope for loading the item into the pocket. Advancing the web to align the second strip with the sealing device includes skipping one or more of the strips of the bonding element without forming a seal therefrom.

In another aspect of the disclosed technology, skipping one or more of the strips of the bonding element without forming a seal therefrom includes advancing the one or more of the strips of the bonding element past the sealing device without forming a seal therefrom.

In another aspect of the disclosed technology, the method further includes skipping one or more of the strips of the bonding element without forming a seal therefrom to advance the web by a distance corresponding to a desired dimension of the envelope in a lengthwise direction of the web.

In another aspect of the disclosed technology, the method further includes skipping a predetermined number of the strips of the bonding element without forming a seal therefrom to advance the web by the distance corresponding to the desired dimension of the envelope in the lengthwise direction of the web.

In another aspect of the disclosed technology, skipping one or more of the strips of the bonding element without forming a seal therefrom includes skipping the strips of the bonding element located between the first and second strips on the first surface.

In another aspect of the disclosed technology, a system for forming an envelope includes a web. The web has a first flexible wall, and a second flexible wall overlying the first flexible wall and affixed to the first flexible wall about at least a portion of a pocket border that encloses a pocket defined between the first and second flexible walls and configured to contain an item. The web also includes a bonding element configured in a plurality of strips each extending across the first flexible wall.

The system also includes a bagging machine having a sealing device configured to heat the strips of the bonding element, a drive mechanism configured to advance the web past the sealing device in a first direction of the web, and a controller communicatively coupled to the drive mechanism. The controller is configured to, based on a selected dimension of the envelope in the first direction of the web, cause the drive mechanism to selectively align a first and a second one of the strips of the bonding element with the sealing device so that the first and second strips are sequentially heated by the sealing device to form respective first and second seals between the first and second flexible walls, and to advance at least one of the strips of the bonding element past the sealing device without the at least one of the strips of the bonding element being heated by the sealing device.

In another aspect of the disclosed technology, the controller is configured to advance a third of the strips of the bonding element past the sealing device without the third strip being heated by the sealing device.

In another aspect of the disclosed technology, the first and the second strips are spaced apart by a first distance about equal to the selected dimension of the envelope in the first direction of the web, and the drive mechanism is further configured to advance the web in the first direction of the web by the first distance after the first seal is formed.

In another aspect of the disclosed technology, the third strip is located between the first and second strips on the web.

In another aspect of the disclosed technology, the first and third strips are spaced apart on the web by a second distance less than the first distance.

In another aspect of the disclosed technology, the first, second, and third strips extend across the first flexible wall in a second direction transverse to the first direction of the web.

In another aspect of the disclosed technology, the drive mechanism includes a traction roller and a drive motor.

In another aspect of the disclosed technology, the system further includes a cutting device configured to separate the envelope from the web by forming a line of separation through the second seal.

In another aspect of the disclosed technology, the envelope is a first envelope, and the controller and the drive mechanism are further configured to advance the web by a second distance after the first envelope is separated from the web. The second distance corresponds to a selected dimension of a second envelope in the first direction of the web.

In another aspect of the disclosed technology, the second distance is unequal to the first distance.

In another aspect of the disclosed technology, the drive mechanism is configured to advance the web by the second distance to align a fourth strip of the bonding element with the sealing device, and the sealing device is configured to form a third seal between the first and second flexible walls from the fourth strip of the bonding element.

In another aspect of the disclosed technology, the controller is configured to cause the drive mechanism and the sealing device to skip one or more of the strips of the bonding element without the one or more of the strips of the bonding element being heated by the sealing device.

In another aspect of the disclosed technology, the controller is configured to cause the drive mechanism and the sealing device to skip one or more of the strips of the bonding element without the one or more of the strips of the bonding element being heated by the sealing device to advance the web by a distance corresponding to the selected dimension of the envelope in the first direction of the web.

In another aspect of the disclosed technology, the controller is configured to cause the drive mechanism and the sealing device to skip a predetermined number of the strips of the bonding element without the predetermined number of the strips of the bonding element being heated by the sealing device to advance the web by a distance corresponding to the selected dimension of the envelope in the first direction of the web.

In another aspect of the disclosed technology, the controller is configured to cause the drive mechanism and the sealing device to skip one or more of the strips of the bonding element located between the first and second strips without being heated by the sealing device.

In another aspect of the disclosed technology, the system further includes a sensor communicatively coupled to the controller and configured to detect a presence of the strips of the bonding element within a sensing field of the sensor.

In another aspect of the disclosed technology, the bonding element includes a heat-activatable material.

In another aspect of the disclosed technology, the web is formed from paper.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a perspective view of an envelope having a heat-sealable adhesive disposed on an internal surface thereof in closely-spaced transverse strips, depicting the envelope being loaded;

FIG. 2 is a cross-sectional view of the envelope shown in FIG. 1, taken through the line II-II of FIG. 1;

FIG. 3 is a perspective view of the envelope shown in FIG. 1, in a loaded and fully sealed condition;

FIG. 4 is a perspective view of two sheets each having the heat-sealable material adhesive thereon being fixed to each other to form a web used to form the envelope shown in FIGS. 1-3;

FIG. 5 is a perspective view of a bagging machine forming the web shown in FIG. 4 into the envelope shown in FIGS. 1-3;

FIG. 6 is a block diagram depicting various electrical and electronic components of the bagging machine shown in FIG. 5;

FIG. 7 is a side view of a cutting blade of the bagging machine shown in FIG. 5;

FIG. 8 is a perspective view depicting the formation of an alternative embodiment of a web;

FIG. 9 is a perspective view depicting the formation of another alternative embodiment of a web;

FIG. 10 is a perspective view of another bagging machine forming an alternative embodiment of an envelope; and

FIG. 11 is a perspective view of another bagging machine forming another alternative embodiment of an envelope.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

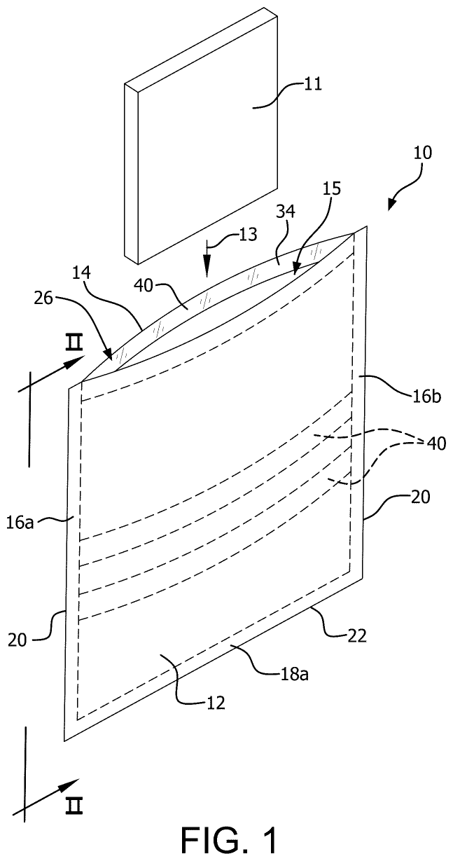

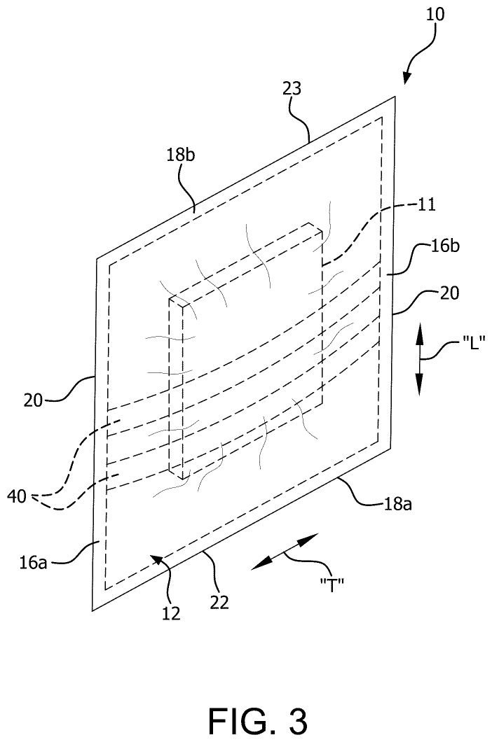

The present technology is directed to an item of parcel packaging. FIGS. 1 and 3 depict an item of parcel packaging in the form of an envelope 10. The envelope 10 is configured to contain and hold an item to be packaged, typically enclosing the item, while the item is being mailed or shipped, or otherwise needs to be packaged in a closed container. The item to be packaged is depicted in FIGS. 1 and 3, and is designated by the character 11. This particular application is presented for illustrative purposes only. The disclosed technology can be applied to other types of parcel packaging.

Directional terms such as “top,” “bottom,” “upper,” “lower,” etc. are used in relation to the component orientations depicted in FIG. 1. These terms are used for illustrative purposes only and are not intended to limit the scope of the claims.

Referring to FIGS. 1-3, the envelope 10 comprises an envelope body that includes a wall 12 and an opposing wall 14. The wall 14 is fixed to the wall 12 by longitudinal inter-wall seals 16a, 16b, and by transverse inter-wall seals 18a, 18b. The walls 12, 14 define an internal containment area or envelope pocket 15 that receives the item being held within the envelope 10. The envelope pocket 15 is visible, in part, in FIG. 1.

The walls 12, 14 can be formed from a stock material in the form of regular kraft paper. The basis weight of the paper is application-dependent and can vary with factors such as the load to which the envelope 10 will be subjected when loaded with the item 11.

In alternative embodiments, one or both of the walls 12, 14 can be formed from extensible paper. For example, the extensible paper can have a stretch, i.e., extensibility, between about three percent to about 25 percent in both the machine and cross-machine directions; a tensile strength between about 25 lbs/inch to about 65 lbs/inch in both the machine and cross-machine directions; a tear strength between about 60 grams and about 180 grams in both the machine and cross-machine directions; and a TEA between about 10 ft-lb/ft² and about 30 ft-lb/ft² in the both the machine and cross-machine directions. An example of an extensible paper from which one or both of the walls 12, 14 can be formed is a single ply of 55-pound (ream weight) paper sold by Canadian Kraft Paper Industries Ltd. of Manitoba, Canada, as “SPX® extensible Kraft paper,” which has a stretch, i.e., extensibility, of about 6.8 percent in the machine direction and about 8.9 percent in the cross-machine direction; a tensile strength of about 45.7 lbs/inch in the machine direction and about 33.1 lbs/inch in the cross-machine direction; a tear strength of about 110 grams in the machine direction and about 120 grams in the cross-machine direction; and a TEA of about 19.2 ft-lb/ft² in the machine direction and about and 20.9 ft-lb/ft² in the cross-machine direction. Other types of paper can be used in the alternative. For example, the walls 12, 14 each can be formed from a single ply of 30-pound to 90-pound “SPX® extensible Kraft paper,” depending on the degree of strength of the walls 12, 14 required for a particular application. Other suitable weights can be used in other embodiments.

In other alternative embodiments of the envelope 10, one or both of the walls 12, 14 can be formed from a non-extensible paper other than regular kraft paper, or another type of material such as polyethylene.

In other alternative embodiments of the envelope 10, one or both of the walls 12, 14 can have a multi-ply configuration.

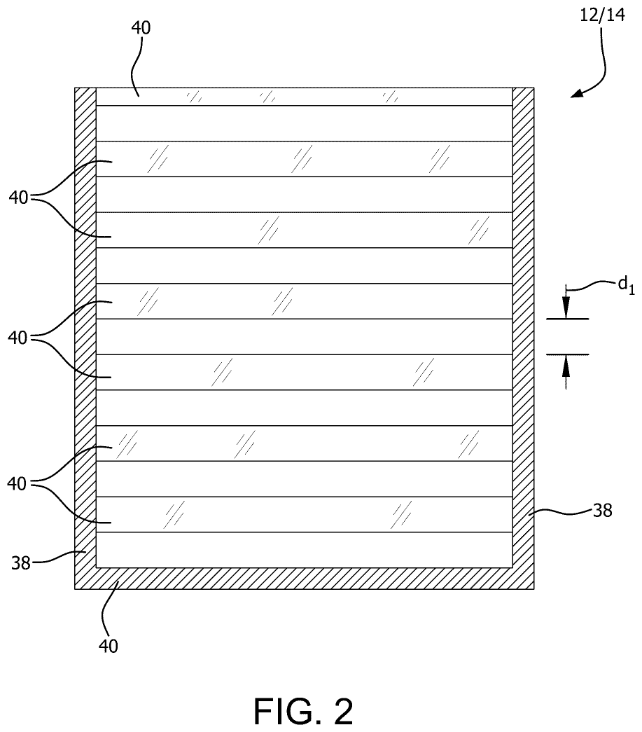

The inter-wall seals 16a, 16b and the inter-wall seals 18a, 18b can be heat seals formed from a bonding element in the form of a heat-sealable material 34, visible in FIGS. 1 and 2. Other types of bonding elements, such as a hot-melt adhesive or a cold adhesive covered with a release layer, that form other types of seals can be used lieu of the heat-sealable material 34 in alternative embodiments.

A heat seal typically is formed by sealing one thermoplastic to the same or a similar thermoplastic. The thermoplastic material(s) typically is applied to the two substrates to be fixed to each other, typically as a coating applied to each surface. In some embodiments, the heat sealable material can be applied as a tape. The heat sealable material, after application, typically is solid in form.

An example of a heat sealable coating material is a weldable polymer provided in a thickness and with a composition such that upon applying sufficient heat to the coating and pressure to the substrates to pressure the opposing coatings against each other, the heat sealable material of the coatings melts and becomes welded together upon cooling, thereby forming a heat-seal of one substrate to the other. Typical heat sealable coatings are made of thermoplastics. The heat sealable material on the opposing surfaces of the substrates typically is identical. In some embodiments, non-identical materials can be used in the coating provided the materials are similar enough such that the materials can melt and combine to become welded together upon cooling.

In some embodiments, the heat-sealable material can include emulsion-based polymers and polymer dispersions. The one or more polymers can include one or more of vinyl acetate ethylene, polyvinyl acetate, polyvinyl alcohol, polyvinyl acetate copolymers, polyvinyl alcohol copolymers, dextrin stabilized polyvinyl acetate, vinyl acetate copolymers, ethylene copolymers, vinylacrylic, styrene acrylic, acrylic, styrene butyl rubber, polyurethane, polyolefins, and biodegradable materials (e.g., cellulose and starch). For example, the heat-activatable material can be a polyvinyl alcohol (PVOH) coating. In some applications, the PVOH can be coated with polyethylene (PE) or polylactic acid (PLA) to prevent the PVOH from sticking, or from absorbing moisture which causes sticking.

In some embodiments, the heat-sealable material can include a polyolefin-based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example HYPOD™, from Dow Chemical, or other suitable polyolefin dispersions.

In some embodiments, the heat-sealable material can be water-based. The water-based heat-sealable material may include a water-based polymer. The use of a water-based heat-sealable material can enhance the recyclability of the packaging material 12, since the water-based heat-sealable material can be dissolved and separated easily from the paper pulp during the recycling process.

The inter-wall seals 16a, 16b and the inter-wall seals 18a, 18b fix the walls 12, 14 to each other, and define a pocket border of the envelope pocket 15. The inter-wall seals 16a, 16b are substantially identical. As can be seen in FIGS. 1 and 3, the inter-wall seals 16 are located along respective side edge portions 20 of the envelope 10, and extend continuously in a longitudinal direction of the envelope 10, along the entire length of the side edge 20. The longitudinal direction is denoted in FIG. 3 by the arrow “L.” The inter-wall seals 16a, 16b can be offset from the respective side edge portions 20 of the envelope 10 in alternative embodiments. Also, the inter-wall seals 16a, 16b can extend over less than the entire length of the side edge portions 20, and/or can be non-continuous in alternative embodiments.

The inter-wall seals 18a, 18b are substantially identical. The inter-wall seal 18a extends continuously along a bottom edge portion 22 of the envelope 10, in a transverse direction, i.e., in a direction substantially perpendicular to the longitudinal direction, and intersects the inter-wall seals 16. The transverse direction is denoted in FIG. 3 by the arrow “T.”

The inter-wall seal 18b extends continuously along a top edge portion 23 of the envelope 10, in the transverse direction. The inter-wall seals 18a, 18b can be offset from the respective bottom edge portion 22 and top edge portion 23 in alternative embodiments. Also, the inter-wall seals 18a, 18b can extend over a distance less than the distance between the inter-wall seals 16a, 16b, and/or can be non-continuous in alternative embodiments. The inter-wall seals 16a, 16b and the inter-wall seals 18a, 18b form the completed pocket border within which the item 11 is retained in the envelope 10.

The inter-wall seals 16a, 16b and the inter-wall seals 18a, 18b each have a width of, for example, about 0.1 inch to about 0.5 inch. The inter-wall seals 16a, 16b and the inter-wall seals 18a, 18b can have a width above or below this range in alternative embodiments.

The heat-sealable material 34 is disposed on the inwardly-facing surface of both of the walls 12, 14. In alternative embodiments, the heat-sealable material 34 can be disposed on only one of the walls 12, 14.

The heat-sealable material 34 can be applied as continuous strips 38, 40 when the envelope 10 is being formed. The strips 38 extend in a lengthwise direction, along respective side edges of the walls 12, 14, as can be seen in FIG. 2. FIGS. 1 and 3 depict a limited number of strips 40 of the heat sealable material 34 on the interior side of wall 12, indicated with broken lines. The depiction of only a limited number of strips 40 is intended for illustrative purposes and does not represent the actual quantity of strips 40 on the envelope 10. As discussed below, the strips 38, once activated by the application of heat and pressure, form the inter-wall seals 16a, 16b of the envelope 10.

The strips 40 of heat-sealable material 34 are parallel, and extend transversely across the envelope 10. Each strip 40 is spaced from its adjacent strips by a common distance “d₁” so that the strips 40 are disposed in a repeating arrangement along the lengthwise direction “L” of the walls 12, 14. For example, in some embodiments, the distance d₁ can be about 0.5 inch to about 5 inches. In other embodiments, the distance d₁ can be about 1 inch to about 4 inches. In other embodiments, the distance d₁ can be about 1 inch to about 2 inches. The spacing between the strips 40 can be non-uniform, in alternative embodiments.

The relative proportions of the strips 38, 40 to the areas on the inside surfaces of the walls 12, 14 that are not covered by the heat-sealable material 34 can vary from that shown in the figures.

The strips 40 of heat-sealable material 34 are selectively activated at the specific locations on the walls 12, 14 at which the inter-wall seals 18a, 18b are to be formed. Because the inter-wall seals 18a, 18b are located at the respective top and bottom of the envelope 10, the specific strips 40 that are activated to form the inter-wall seals 18a, 18b are spaced apart by the approximate height of the envelope 10, while the strips 40 located between the inter-wall seals 18a, 18b remain un-activated, thereby allowing the height of the envelope 10 to be set by the selective activation of specific strips 40. The localized application of heat and pressure activates the heat-sealable material 34 at the specific locations at which the walls 12, 14 are to be fixed to each other, while the remainder of the heat-sealable material 34 on the walls 12, 14 remains un-activated. The walls 12, 14, therefore, do not adhere to each other at locations other than the locations of the inter-wall seals 16a, 16b, 18a, 18b.

The walls 12, 14 initially are fixed to each other by the formation of the inter-wall seals 16a, 16b (which are located along the sides the envelope 10), and the inter-wall seal 18a (which is located along the bottom of the envelope 10), so that the walls 12, 14 can be spread apart to define an opening 26 to the upper end of the envelope pocket 15 as shown in FIG. 1. The opening 26 is located at the top of the envelope 10, and permits the item 11 to be inserted into the envelope pocket 15. More specifically, the wall 12 overlies the wall 14 and is fixed to the wall 14 about the portion of the pocket border defined by the inter-wall seals 16a, 16b and the inter-wall seal 18a, with the partially-formed pocket border enclosing the envelope pocket 15 defined between the walls 12, 14, and with at least one of the walls 12, 14 defining the opening 26 that allows access to the envelope pocket 15 from an exterior of the envelope 10 for loading an item into the envelope pocket 15.

The strip 40 of heat-sealable material 34 along the top edge portion 23 of the envelope 10 can be activated after the item 11 has been inserted into the envelope pocket 15, to form the inter-wall seal 18b. The inter-wall seal 18b functions as a closure seal that fixes the upper ends of the walls 12, 14 to each other, to maintain the opening 26 in a closed state so that the packaged item 11 is retained within the envelope 10.

The heat-sealable material 34 can be a thermoplastic material. Other types of materials can be used in the alternative. The heat-sealable material 34 can be applied to the respective surfaces of the sheets 32a, 32b as a liquid, using suitable methods such as brushing, spraying, rollers, knife over roll, reverse roll, nip roller, gravure coating, rod coating, etc. Upon drying following its application, the heat-sealable material 34 is non-tacky, or has a tackiness that is sufficiently low to prevent the opposing surfaces of the sheets 32a, 32b from adhering to each other unless and until the heat-sealable material 34 is activated. The heat-sealable material 34 subsequently can be activated by the application of heat and pressure sufficient to weld the heat-sealable material 34 on the respective sheets 32a, 32b together, thereby forming a seal between the sheets 32a, 32b. The heat-sealable material 34 can be activated locally, by the focused application of heat and pressure, to form the seals 16a, 16b, 18a, 18b at specific locations on the sheets 32a, 32b.

The heat-sealable material 34 will not stick to other surfaces when cold because it has no tackiness, or minimal tackiness until it is activated, i.e., heated to a sealable temperature within a lower range of temperatures. For example, this lower range of temperatures in some embodiments is below about 140° F. In other embodiments, for example, the lower range of temperatures is below about 120° F., below about 125° F., or below about 130° F.

The heat-sealable material 34 can be a water-based or a solvent-based formulation. In alternative embodiments, the heat-sealable material 34 can be applied to the sheets 32a, 32b as a tape.

In alternative embodiments, a low-tackiness hot-melt adhesive can be used in lieu of the heat-sealable material 34 to fix the walls 12, 14 to each other. Hot-melt adhesives are thermoplastic polymers that are solid at room temperature, become molten when heated to an activation temperature above their softening point, and resolidify upon loss of heat at a temperature below a solidifying point, which may be the same as or different than the activation temperature, increasing in strength as they re-solidify. Most hot-melt adhesives, upon melting into a molten state and re-solidifying, do not undergo any chemical reaction such as cross-linking or removal of a carrier, e.g., evaporation of water. Thus, hot-melt adhesives typically can be reactivated, i.e., re-melted and re-solidified, after initially being applied to a substrate.

The hot-melt adhesive, after being applied to the sheet 32a or the sheet 32b, is in a low-tackiness state in which it has a low, or no tackiness in a lower range of temperatures. The hot-melt adhesive is reactivatable. More specifically, the hot-melt adhesive is applied hot, and cools and cures in the converting process. The hot-melt adhesive is reactivated by re-heating the hot-melt adhesive up to an activation temperature within a lower range of temperatures. This lower range of application temperatures in some embodiments, for example, is below about 140° F. In other embodiments, for example, the lower range of temperatures is below about 120° F., below about 125° F., or below about 130° F.

The re-heating of the hot-melt adhesive to the activation temperature causes the hot-melt adhesive to become molten. The subsequent cooling of the hot-melt adhesive, in combination with the application of pressure on the first and/or second sheet 32a, 32b, causes the hot-melt adhesive to bond to the opposing surface of the sheet 32a or the sheet 32b, forming a seal between the sheets 32a, 32b. The hot-melt adhesive can be re-activated locally, by the focused application of heat and pressure, to form the seals at specific locations the sheets 32a, 32b.

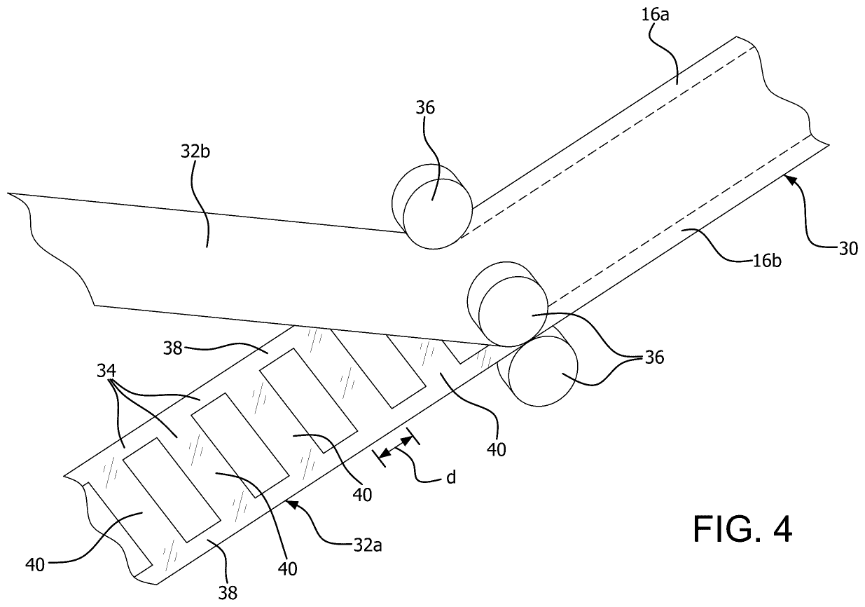

The envelopes 10 can be pre-formed as part of a continuous web 30. FIG. 4 depicts the manufacture of the web 30 using an automated device. More specifically, FIG. 4 shows two sheets of paper 32a, 32b that, when joined in the following manner, form the continuous web 30 from which the envelopes 10 subsequently can be formed.

The heat-sealable material 34 is deposited on the sheet 32a in a pattern, as shown in FIG. 4. In some embodiments, the heat-sealable material 34 can be applied to only one of the sheets 32a, 32b. The parallel, closely-spaced strips 40 of heat-sealable material 34 on the upward-facing surface of the sheet 32a are visible in FIG. 4. In alternative embodiments, the strips 40 of heat-sealable material 34 can have different or uneven spacing. The strips 38 of heat-sealable material 34 disposed along the side edges of the upward-facing surface of the sheet 32a likewise are visible in FIG. 4.

Referring to FIG. 4, the sheet 32b initially is positioned above the sheet 32a, so that the surfaces of the sheets 32a, 32b to which the heat-sealable material 34 has been applied face each other. Also, the sheet 32b is positioned so that the longitudinal, i.e., side, edges of the sheet 32b align with respective longitudinal edges of the sheet 32a. Heated rollers 36 of the automated device then press the sheet 32b into the underlying sheet 32a at, and near the respective longitudinal edges of the sheets 32a, 32b. The rollers 36 also heat the respective portions of the sheets 32a, 32b underlying the rollers 36. The combination of heat and pressure at and near the longitudinal edges of the sheets 32a, 32b locally activate the heat-sealable material 34 located between the rollers 36, forming the inter-wall seals 16a, 16b. The inter-wall seals 16a, 16b fix the sheets 32a, 32b to each other, thereby forming the web 30, with the sheets 32a, 32b forming respective walls of the web 30.

At this point, the web 30 has been fully formed, with the longitudinal, or side edges fixed to each other by the inter-wall seals 16a, 16b. All the transverse strips 40 of heat sealable material 34 are in an un-activated state, so that the portions of the sheets 32a, 32b located between the inter-wall seals 16a, 16b are not fixed to each other at any point thereon.

In alternative embodiments, one or more heated plates can be used in lieu of the rollers 36 to apply heat and pressure at and near the longitudinal edges of the sheets 32a, 32b to activate the heat-sealable material 34. Other devices for applying heat and pressure at and near the longitudinal edges of the sheets 32a, 32b to activate the heat-sealable material 34 can be used in other alternative embodiments.

Individual envelopes 10 can be formed from the web 30 as discussed below, with the walls 12, 14 of the completed envelopes 10 being formed from the walls of the web 30, i.e., from the respective sheets 32b, 32a. Because the transverse strips 40 of the heat-sealable sealable material 34 are closely-spaced along the length of the web 30 and initially are un-activated, the inter-wall seals 18a, 18b, which define the top and bottom of each envelope 10, can be selectively formed at various locations along the length of the web 30 so as to permit the height of each envelope 10, i.e., the dimension of the envelope 10 in the longitudinal direction of the web 30, to be varied or otherwise selected by the user. The size of the envelopes 10 thus can be tailored to the requirements of a particular application, through the selective formation of the inter-wall seals 18a, 18b along the length of the web 30, i.e., by activating only the transverse strips 40 of heat sealable material 34 spaced apart by a distance corresponding approximately to the desired height of the particular envelope 10 being produced (with the remaining strips 40 remaining un-activated).

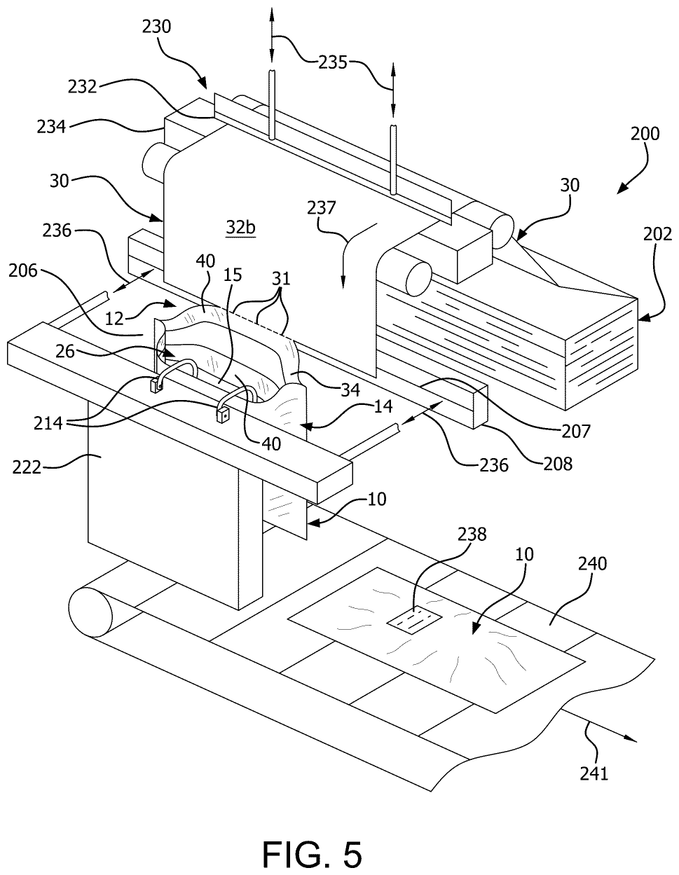

For example, the envelopes 10 can be formed from the web 30 into their final configuration, loaded, sealed, and separated from the web 30 by a bagging machine 200 depicted in FIG. 5. The bagging machine 200 is described for illustrative purposes only. The envelopes 10 can be formed into their final configuration, loaded, sealed, and/or separated from the web 30 manually, and by other automated means, in the alternative.

As discussed in detail below, the bagging machine 200 is configured to form the inter-wall seals 18a, 18b in the web 30, to define a fully-formed envelope 10 at the leading end of the web 30. The bagging machine 200 also separates the fully-formed envelope 10 from the web 30 after the envelope 10 has been loaded and sealed.

The bagging machine 200 also is configured to facilitate loading of the item 11 into the envelope pocket 15, and sealing of the envelope pocket 15 once the item 11 has been loaded. As explained in detail below, the bagging machine 200 can make a transverse cut, such as a kiss cut, in the sheet 32b of the web 30 at a location corresponding to the top of the envelope 10 being formed, to define the wall 12 of the envelope 10. The kiss cut (or other type of cut) can be made along one of the strips 40 of the heat-sealable material 34. After forming the kiss cut and advancing the web 30, the bagging machine 200 pulls the upper end of the newly-formed wall 12 away from the wall 14 (which is formed by the underlying sheet 32a), to define the opening 26 to the envelope pocket 15, thereby allowing the item to be packaged 11 to be loaded into the envelope pocket 15. Once the item 11 has been loaded, the bagging machine 200 forms the inter-wall seal 18b, so that the item 11 is retained within the envelope pocket 15. The bagging machine 200 then separates the fully formed, loaded, and sealed envelope 10 from the web 30.

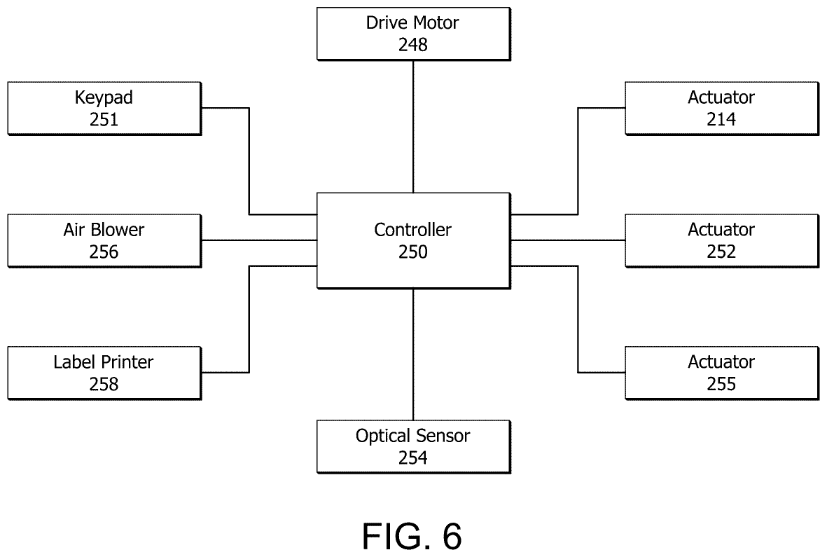

Referring to FIGS. 5-7, the web 30 can be supplied as a stack 202 having a fan-folded configuration. The bagging machine 200 can include traction rollers (not shown) driven by a drive motor 248. The drive motor 248 is communicatively coupled to a controller 250 of the bagging machine 200, as depicted diagrammatically in FIG. 6. The traction rollers draw the web 30 from the stack 202 in an unexpanded, high-density configuration, and advance the web 30 into, and through the bagging machine 200 as denoted by the arrow 237 in FIG. 5. The web 30 can be provided in configurations other than a fan-folded stack, such as a roll, in the alternative.

The bagging machine 200 further includes a cutting device 230. The cutting device 230 forms the above-noted kiss cut in the sheet 32b of the web 30, to define the wall 12. In addition, the cutting device 230 forms lines of weakness, such as perforations 31, in the underlying sheets 32a. The perforations 31, as discussed below, facilitate separation of the envelope 10 from the web 30 once the envelope 10 has been loaded and sealed.

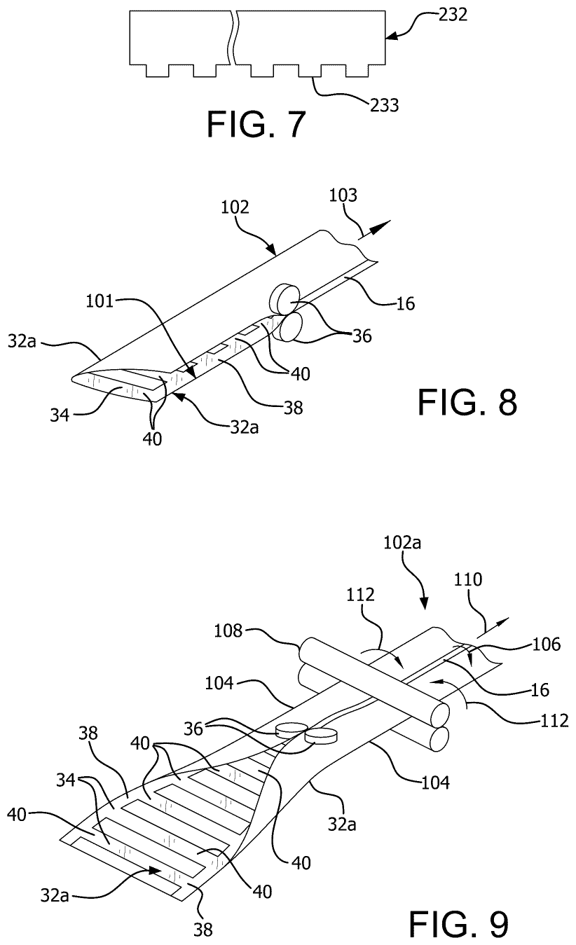

The cutting device 230 has a cutting blade 232, and an anvil 234 that underlies the cutting blade 232. The cutting blade 232 is coupled to an actuator 252 configured to move the cutting blade 232 toward and away from the anvil 234, between a retracted position shown in FIG. 5 and a cutting position (not shown). The actuator 252 is communicatively coupled the controller 250, as depicted diagrammatically in FIG. 6. The direction of movement of the cutting blade 232 is indicated by the arrows 235 in FIG. 5. The cutting blade 232 has a serrated cutting surface 233, shown in FIG. 7. The cutting surface 233 is configured to form a kiss cut in an overlying layer, i.e., the sheet 32b, of a two-ply material, i.e., the web 30, placed between the cutting surface 233 and the anvil 234. The cutting surface 233 is further configured to form the perforations 31 in the underlying layer of material, i.e., the sheet 32a. The kiss cut and the perforations 31 formed in this manner overlap.

In alternative embodiments, the kiss cut and the perforations 31 can be formed at different points in the loading and sealing process and can be offset in relation to each other. For example, the kiss cut and the perforations 31 can be made using separate cutting devices on opposite sides of the web 30 in lieu of the cutting device 230, with the perforations 31 being formed before the kiss cut is made and being located upstream of the kiss cut. In other alternative embodiments, the perforations 31 can be formed after the kiss cut is made and/or can be located downstream of the kiss cut.

A loading and sealing cycle for an envelope 10 can proceed as follows. After separating a fully formed, loaded, and sealed envelope 10 from the web 30, the bagging machine 200 begins the next cycle by advancing the web 30 so that the location on the web 30 at which the next inter-wall seal 18b is to be formed aligns with the cutting blade 232. This location corresponds to the location of one of the transverse strips 40 of the heat-sealable material 34. For example, the web 30 can be advanced so that the next consecutive strip 40 aligns with the cutting blade 232. Alternatively, the web 30 can be advanced so that a transverse strip 40 is spaced from the strip 40 activated during the previous cycle by skipping strips 40 by intervals, i.e., by skipping one or more other strips 40, until transverse strip 40 intended to form the next inter-wall seal 18b aligns with the cutting blade 232. As explained below, the upper half of the transverse seal that was formed during the previous cycle is positioned at the leading end of the web 30 (which is now located below the cutting blade 232 due the advancement of the web 30), and forms the lower inter-wall seal 18a of the envelope 10 being produced during the current cycle.

The bagging machine 200 can be equipped with a suitable device, such as an optical sensor 254, that senses the presence of one or more of the strips 40 within its sensing field. The optical sensor 254 is communicatively coupled to the controller 250 and is depicted diagrammatically in FIG. 6. The optical sensor 254 generates and sends to the controller 250 an output indicating the presence of the strips 40.

The extent to which the web 30 is advanced is related to the desired height of the envelope 10 being formed. As noted above, the transverse strips 40 of the heat-sealable material 34 on the sheets 32a, 32b permit the inter wall seals 18a, 18b, which define the respective bottom and top ends of the envelope 10, to be selectively formed at specific locations along the length of the web 30. Because the previously formed inter-wall seal 18a is located at the end of the web 30, the extent to which the web 30 is advanced at this point in the cycle determines the spacing between the inter-wall seals 18a, 18b, which in turn determines the height, or lengthwise dimension of the envelope 10. For example, the web 30 can be advanced so that the next consecutive strip 40 aligns with the cutting blade 232. Alternatively, the web 30 can be advanced so that a transverse strip 40 is spaced from the strip 40 activated during the previous cycle by skipping strips 40 by intervals, i.e., by skipping one or more other strips 40, until transverse strip 40 intended to form the next inter-wall seal 18b aligns with the cutting blade 232. This in turn permits the height and the internal volume of the envelope 10 to be varied, so that the height and the internal volume of the envelope 10 can be tailored to a particular application. Thus, a single web 30 can be used to produce envelopes 10 of different sizes and volumes, negating the need to change the web 30 when a different-sized envelope 10 is to be produced on the bagging machine 200.

The desired height for a particular envelope 10 or a particular series of envelopes 10 can be input to the controller 250 of the bagging machine 200, for example, by an operator using an input device such as a keypad 251 communicatively coupled to the controller 250. The keypad 251 is depicted diagrammatically in FIG. 6. The controller 250 is communicatively coupled to the drive motor 248 of the traction rollers, and is configured to actuate the drive motor 248 to cause the traction rollers to advance the web 30 automatically, by a distance that will result in the desired envelope height.

Once the location on the web 30 at which the next inter-wall seal 18b is to be formed aligns with the cutting blade 232, the cutting blade 232 is advanced toward the cutting position. As the cutting blade 232 reaches the cutting position, the cutting blade 232 presses the web 30 into, and against the anvil 234, so that the serrated cutting surface 233 of the cutting blade 232 makes a kiss cut in the sheet 32b, while simultaneously making a series of cuts in the sheet 32a to form the perforations 31. The kiss cut and the perforations 31 can extend in a transverse direction across the web 30, between, but not through, the inter-wall seals 16a, 16b.

The bagging machine 200 also includes a sealing device such as a cutter-sealer 206, and a second anvil (not shown) that opposes the cutter-sealer 206. The cutter-sealer 206 is coupled to an actuator 255 configured to move the cutter-sealer 206 toward and away from the second anvil, between an inward or extended position (not shown), and an outward or retracted position shown in FIG. 5. The actuator 255 is communicatively coupled to the controller 250, as depicted diagrammatically in FIG. 6. The direction of movement of the sealer-cutter 206 is indicated by the arrows 236 in FIG. 5. The bagging machine 200 also includes an opening device in the form of, for example, fingers 214 mounted on the cutter-sealer 206.

Once the kiss cut and the perforations 31 have been formed in the web 30, the bagging machine 200 advances the web 30 until the lengthwise location on the web 30 at which the next inter-wall seal 18b is to be formed aligns with the cutter-sealer 206. As noted above, the lengthwise location at which the next inter-wall seal 18b is to be formed coincides generally with the location of the kiss cut and the perforations 31. The cutter-sealer 206 next moves inward, toward its extended position, so that the fingers 214 can grasp and pinch the upper end of the wall 12. The cutter sealer 206 then moves outward, toward its retracted position, causing the fingers 214 to pull the upper end of the wall 12 away from the upper end of the wall 14, forming the opening 26 at the top of the envelope 10, as shown in FIG. 5. The perforations 31 in the sheet 32a help to facilitate the movement of the wall 12 away from the wall 14, as depicted in FIG. 5.

At this point, the partially formed envelope 10 is ready to be loaded with the item to be packaged 11. As can be seen in FIG. 5, the flexible walls 12, 14 can assume a generally concave shape that permits the envelope pocket 15 to accommodate the item 11. The envelope 10 remains attached to the remainder of the web 30 by the material between the remaining perforations 31. The walls 12, 14 of the envelope 10, which are formed from the respective sheets 32b, 32a, are bounded on their sides by the inter-wall seals 16a, 16b which were formed during the formation of the web 30. The walls 12, 14 are bounded on their lower ends by the inter-wall seal 18a that was formed in the web 30 during formation of the previous envelope 10, i.e., during the previous loading and sealing cycle performed by the bagging machine 200. Because the inter-wall seal 18b has not yet been formed, the walls 12, 14 are not yet attached to each other at their respective upper ends, and the envelope pocket 15 is accessible by way of the opening 26.

The bagging machine 200 also can include an air blower 256 configured to direct pressurized air at the top of the envelope 10, to aid in separating the walls 12, 14. The air blower 256 is communicatively coupled to the controller 250, as depicted in FIG. 6. Once the opening 26 to the envelope pocket 15 has been formed, the item to be packaged 11 can be loaded into the envelope pocket 15 manually through the opening 26, or by automated machinery.

The opening device can have a configuration other than the fingers 214 in alternative embodiments. For example, articulating suction cups can be used as the opening device in alternative embodiments. In other alternative embodiments, the pressurized air from the air blower 220 can be used to open the envelope 10. In other alternative embodiments, the envelope 10 can be opened manually, without the use of an opening device.

After the item 11 has been loaded into the envelope pocket 15, the cutter-sealer 206 moves inwardly, toward its extended position. The wall 12 of the envelope 10, which is still being grasped and pinched by the fingers 214, moves inwardly, toward the wall 14, in response to the inward movement of the articulating jaw 206. The continued inward movement of the cutter-sealer 206 eventually causes the adjacent portion of the web 30 to become sandwiched between the cutter-sealer 206 and the second anvil. The cutter-sealer 206 acts as a sealing device by locally heating the particular strip 40 of the heat-sealable material 34 located between the cutter-sealer 206 and the second anvil. This strip 40 extends transversely across the envelope 10, between the inter-wall seals 16a, 16b. Also, the cutter-sealer 206 presses the web 30 into the second anvil. The combination of heat and pressure imparted by the articulating jaw 206 and the heat sealer 210 results in the formation of a seal that extends transversely across the web 30, between the inter-wall seals 16a, 16b. As discussed below, the transverse seal subsequently is cut to form both the inter-wall seal 18b of the envelope 10 currently being formed, loaded, and sealed; and the inter-wall seal 18a of the next envelope 10 that will be formed from the web 30.

The bagging machine 200 can be equipped with a foam pad 222 that is mounted on, and moves with the cutter-sealer 206 or other mechanism to compress or squeeze the envelope 10 when, for example, the cutter-sealer 206 moves inward, to help drive air out of the envelope pocket 15 before the envelope pocket 15 is sealed. In embodiments that include internal venting, this step can occur at a later point in the bagging process, or can be omitted entirely. The bagging machine 200 also can include a label printer 258 configured to print a label 238, and fix the label 238 to the envelope 10 as shown in FIG. 5. The label printer 258 is communicatively coupled to the controller 250 and is depicted in diagrammatically in FIG. 6.

At this point in the cycle, the envelope 10 has been loaded and sealed, and is ready to be separated from the web 30. The cutter-sealer 206 makes a cut through the newly-formed transverse seal, and through the overlying portions of the sheets 32a, 32b (which now form the respective walls 14, 12 of the newly-formed envelope 10). The cut separates the transverse seal into a lower half, which forms the inter-wall seal 18b of the envelope 10 that has just been loaded and sealed; and an upper half, which forms the inter-wall seal 18a of the next envelope 10 to be formed from the web 30 during the subsequent cycle of the bagging machine 200. In alternative embodiments, the separation of the envelope 10 from the web 30 can be performed using techniques other than cutting, such as the focused application of heat.

Once the loaded envelope 10 has been separated from the web 30, the envelope 10 can drop onto a conveyor 240 or other means for transporting or holding the envelope 10.

The loading and sealing cycle for the next envelope 10 to be produced from the web 30 can commence with the advancement of the web 30 to a position at which the cutting blade 232 is aligned with the location on the web 30 at which the next transvers inter-wall seal is to be formed. As discussed above, the degree of advancement of the web 30 is related to the desired height or length of the next envelope 10 to be formed. The degree of advancement can be greater than, less than, or the same as the degree to which the web 30 was advanced during the previous cycle, depending on whether the next envelope 10 to be formed is to have a height that is greater than, less than, or the same as the previous envelope 10. The inter-wall seal 18a formed during the previous cycle, having been separated from the previously-formed envelope 10 by the cutting process of the previous cycle, is now located at the leading end of the web 30.

The formation of the inter-wall seals 18a, 18b on the bagging machine 200 has been described for illustrative purposes only. In the alternative, the inter-wall seal 18a can be formed along with the inter-wall seals 16 during formation of the web 30, i.e., the web 30 can be supplied to the bagging machine 200 with the inter-wall seals 18a already formed and spaced apart by a distance or distances related to the desired height or heights of the envelopes 10 to be produced from the web 30.

Referring to FIG. 8, in alternative embodiments, the walls 12, 14 can be formed unitarily from a single sheet of paper, such as the sheet 32a, or other stock material that is folded onto itself to produce a web 102 from which the opposing walls 12, 14 can be produced. As discussed above in relation to the web 30, the heat-sealable material 34 can be applied as longitudinal strips 38 located along side edge portions of the sheet 32a, and as strips 40 that extend transversely, between the strips 38.

The sheet 32a can be folded about its longitudinal centerline as denoted by the arrow 101 in FIG. 8, so that the strips 38 of heat-sealable material 34 overlap and align with each other. A pair of heated rollers, such as the heated rollers 36 discussed above in relation to the envelope 10, press the overlapping strips 38 into each other as the sheet 32a is advanced in the direction denoted by the arrow 103 in FIG. 8. The rollers 36 also heat the overlapping edge portions. The combination of heat and pressure on the edge portions of the sheet 32a forms a longitudinal inter-wall seal 16. The inter-wall seal 16 fixes the longitudinal edge portions of the sheet 32a to each other, thereby forming the web 102, with the overlapping halves of the C-folded sheet 32a forming respective walls of the web 102.

Individual envelopes subsequently can be formed from the web 102 in a manner similar to the formation of the envelopes 10 from the web 30. The C-folded envelopes can be formed into their final configuration, loaded, sealed, and separated from the web 102 by a bagging machine 200 or other device as discussed above in relation to the envelopes 10. Because the transverse strips 40 of the heat-sealable sealable material 34 are closely-spaced along the length of the web 102 and initially are un-activated, the inter-wall seals which define the top and bottom of each envelope can be selectively formed at various locations along the length of the web 102 so as to permit the height of each envelope 10 to be varied or otherwise selected by the user.

Referring to FIG. 9, in other alternative embodiments, the sheet 32a can be folded along two longitudinal fold lines 104 to form a web 102a. In particular, the sheet 32a can be folded so that longitudinal edges of the sheet 32a align with each other as shown in FIG. 9. A pair of heated rollers, such as the heated rollers 36 discussed above in relation to the envelope 10, press the overlapping edge portions of the sheet 32a together as the sheet 32a is advanced in the direction denoted by the arrow 110 in FIG. 9. The rollers 36 also heat the overlapping edge portions. The combination of heat and pressure forms a longitudinal inter-wall seal 16. The inter-wall seal 16 fixes the edge portions of the sheet 32a to each other, thereby forming the web 102a.

The web 102a then can be passed between two opposing rollers 108. The rollers 108 extend transversely across the width of the web 102a. The rollers 108 flatten the portion of the web 102a on which the inter-wall seal 16 is formed onto the adjacent portion of the web 102a, as denoted by the arrow 112 in FIG. 9. The rollers 108 also help to define the fold lines 104 in the web 102a.

Individual envelopes subsequently can be formed from the web 102a in a manner similar to the manner in which the envelopes 10 are formed from the web 30. The double C-folded envelopes can be formed into their final configuration, loaded, sealed, and separated from the web 102a by a bagging machine 200 or other device as discussed above in relation to the envelopes 10. Because the transverse strips 40 of the heat-sealable sealable material 34 are closely-spaced along the length of the web 102 and initially are un-activated, the inter-wall seals which define the top and bottom of each envelope can be selectively formed at various locations along the length of the web 102 so as to permit the height of each envelope 10 to be varied or otherwise selected by the user.

In other alternative embodiments, one or both walls 12, 14 can include one or more functional layers positioned thereon. Examples of functional layers can include, but are not limited to, waterproofing layers (configured to reduce permeability of water therethrough), an airtight layer (configured to reduce permeability of air therethrough), other suitable material layers, and/or a combination thereof.

In other alternative embodiments, one or both walls 12, 14 of the envelope 10 can have a multi-layer configuration. For example, the walls 12, 14 each can be formed from two plies of relatively low basis-weight paper, such as two plies of 30 to 45-pound paper. The two plies of 30 to 45-pound paper can be used in lieu of a single ply of 90-pound paper. In such embodiments, one or both of the paper sheets 32a, 32b can have a multi-ply configuration, and can be formed into a web as discussed above in relation to web 30.

For example, in embodiments where the sheet 32a has a two-ply configuration, one or both inward-facing surfaces of the plies can be coated with the heat-sealable material 34 to form longitudinal strips of the heat-sealable material 34 along the side-edge portions of the inward-facing surfaces, and strips that extend transversely between the transverse strips. Longitudinal inter-ply seals can be formed along the side portions of the plies in the manner discussed above in relation to the inter-wall seals 16a, 16b, to fix the plies to each other. The two-ply paper sheet 32a then can be joined to the paper sheet 32b as discussed above to form the web 30.

Transverse inter-ply seals can be formed in the two-ply paper sheet 32a. The transverse inter-ply seals can overlay the inter-wall seals 18a, 18b, and can be formed by the heat and pressure applied to the web 30 to form the inter-wall seals 18a, 18b. The transverse inter-ply seals fix and seal the plies to each other along what will become the respective top and bottom of the wall 14 of the fully-formed envelope 10.

The longitudinal and transverse inter-ply seals formed in the two-ply paper sheet 32a (and/or in a two-ply paper sheet 32b) border, and help to define an interlayer region, or inter-ply space (not shown) between the two plies.

The two plies face each other across the inter-ply space, but are not adhered to each other in the inter-ply space. Also, the inter-ply space is sufficiently empty such that the plies can abut and otherwise contact each other within the inter-ply space, and can slide in relation to each other within the inter-ply space. For example, the inter-ply space can be completely empty, i.e., the inter-ply space can be completely devoid of any filler or other material.

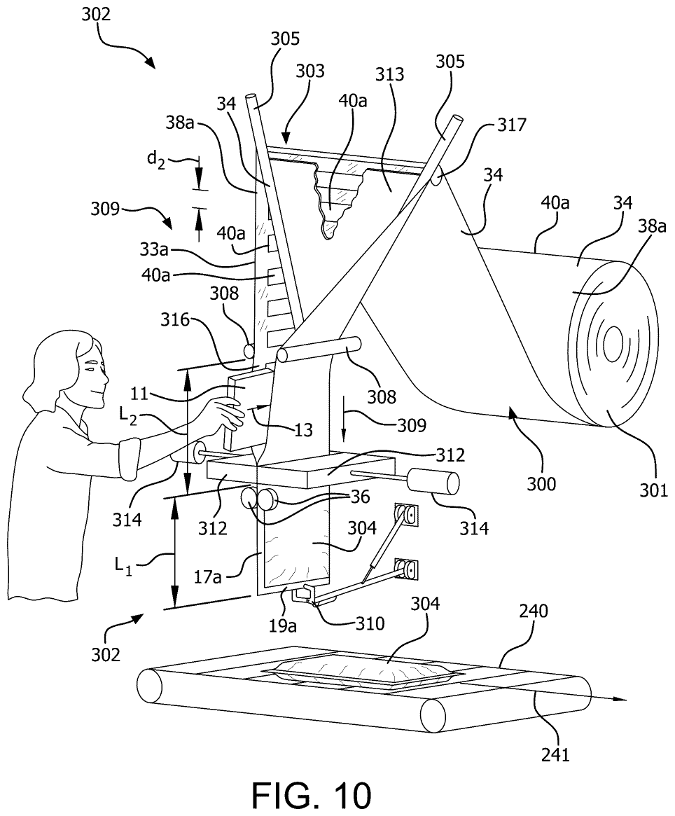

FIG. 10 depicts a bagging machine 302 that forms a web 300 into a C-folded configuration and then seals the folded structure around an item to be packaged 11 to form an envelope 304. The web 300 comprises a single layer in the form of a sheet 33a of regular kraft paper, such as the sheet 32a. The web 300 can be formed from a paper other than regular kraft paper, including extensible paper, in alternative embodiments. The web 300 can be formed from materials other than paper in other alternative embodiments. The web 300 can have a multilayer configuration in other alternative embodiments.

The heat-sealable material 34 can be applied in a continuous strip 38a that extends in a lengthwise direction, along one side edge portion of the sheet 33a. The heat sealable material 34 also can be applied in continuous strips 40a that extend transversely across the width of the sheet 32a. As discussed above in relation to the strips 40 of heat-sealable material 34 on the envelope 10, the strips 40a are parallel, and each strip 40a is spaced from its adjacent strips 40a by a common distance “d₂” so that the strips 40a are disposed in a repeating arrangement along the lengthwise direction “L” of the sheet 33a. For example, in some embodiments, the distance d₂ can be about 0.5 inch to about 5 inches. In other embodiments, the distance d₂ can be about 1 inch to about 4 inches. In other embodiments, the distance d₂ can be about 1 inch to about 2 inches. The spacing between the strips 40a can be non-uniform in alternative embodiments. The strips 38a, 40a can be non-continuous in alternative embodiments.

The web 300 in the form of the sheet 32a can be supplied, for example, as a roll 301 mounted on the supply side of the bagging machine 302, as depicted in FIG. 10. The web 300 can be supplied in other configurations, such as a fan-folded stack, in the alternative.

Bagging machine 302 includes a former 303. Former 303 is depicted in FIG. 10 in a partial cutaway view, for clarity. Former 303 includes a body 313, and angled guides 305 that extend from an upper portion of body 313. Body 313 has a generally triangular configuration, with a pointed vertex or apex 315 at the bottom thereof.

Bagging machine 302 also includes a roller 317 positioned proximate to an upper end of the body 313 of former 303. Web 300 is drawn from the supply roll 301 and over roller 317, at which point web 300 is turned so as to move in a generally downward direction and into contact with body 313, with guides 304 helping to guide web 300 onto body 313. Web 300 then is drawn downward over the rearward side of body 313 (from the perspective of FIG. 10), in the direction denoted by the arrow 309. In some embodiments, bagging machine 302 can be equipped with a dancer or similar equipment configured to adjust tension in web 300. In some embodiments, bagging machine 302 can be equipped with sensors positioned along the path of web 300 to monitor the lateral alignment of web 300 with its intended path.

The web 300 is drawn through opposing guides 308 of the bagging machine 302, in the direction denoted by the arrow 309. The bagging machine 302 can include a pulling device in the form of two opposing arms 310 that reciprocate between an inward position and an outward position. The arms 310 also translate between a lower and an upper position. The arms 310 can grasp a lower end (or other portion) of the web 300 when the arms 310 are in their inward and upper position. Subsequent downward movement of the arms 310 pulls the web 300 downward, causing the web 300 to advance through the bagging machine 302. The pulling device can have other configurations in alternative embodiments.

The guides 308 cause the web 300 to assume a C-folded configuration as the web 300 is drawn through the guides 308. As can be seen in FIG. 10, when the web 300 is folded in this manner, longitudinal side edges of the web 300 align with, and oppose each other; and the halves of the web 300 form respective walls of the web 300.

The bagging machine 302 includes a sealing device, such as a cutting and sealing mechanism that includes two cutting and sealing units 312, and two actuators 314. Each actuator 314 is coupled to a respective cutting and sealing unit 312 and is configured to move the cutting and sealing unit 312 between an inward or extended position shown in FIG. 10, and an outward or retracted position (not shown). The actuators 314 are communicatively coupled the controller 250, as depicted in FIG. 6.

After passing through and being folded by guides 308, the C-folded folded web 300 travels downward, so that a location on the web 300 at which a transverse inter-wall seal is to be formed from a strip 40a of the heat-sealable material 34 is positioned between the cutting and sealing units 312. The cutting and sealing units 312 are moved inward, to their respective extended positions, by their associated actuators 314, so that the noted portion of the web 300 becomes sandwiched between the cutting and sealing units 312. The cutting and sealing units 312 locally apply pressure and heat to the web 300, which activates the underlying strip 40a of heat-sealable material 34 and forms the transverse seal in the web 300.

At this point, as depicted in FIG. 10, a partially formed envelope 304 is bordered on its lower end by the newly-formed transverse seal; and the transverse seal and the C-folded web 300 define a partially-formed envelope pocket 316. An item to be packaged 11 can be inserted into the partially-formed pocket 316, from the side of the web 300, as denoted by the arrow 13 in FIG. 10.

As also shown in FIG. 10, a fully-formed the envelope 304, formed during the previous loading and sealing cycle of the bagging machine 302, is located at the leading end of the web 300, below the cutting and sealing units 312. A pair of heated rollers, such as the heated rollers 36 discussed above in relation to the envelope 10, have pressed the overlapping side edge portions of the web 300 together as the web 300 last advanced. The rollers 36 also heat the portions of the web 300 located between the rollers 36. The combination of heat and pressure at and near the longitudinal edge of the web 300 forms a longitudinal inter-wall seal 17a from the strip 38a of heat-sealable material located along one of the side edge portions of the web 300. The inter-wall seal 17a fixes the longitudinal edge portions of the web 300 to each other, further enclosing and sealing the envelope pocket 316.

The cutting and sealing units 312 make a cut through the newly-formed transverse seal. The cut separates the transverse seal into an upper half, which forms an inter-wall seal 19a at the lower end of the partially-formed envelope 304 that has just been loaded; and a lower half, which forms an inter-wall seal 19b (not shown) at the upper end of the fully formed and loaded envelope 304 at the end of the web 300. The cut also separates the fully formed and loaded envelope 304 from the web 300. In alternative embodiments, the separation of the envelope 304 from the web 300 can be performed using techniques other than cutting, such as the focused application of heat.

In alternative embodiments, each cutting and sealing unit 312 can include, for example, a rolling longitudinal sealer and a horizontal bar. In other alternative embodiments, each cutting and sealing unit 312 can include, for example, a horizontal sealer that rolls or slides across the web 300.

Once the fully formed and loaded envelope 304 has been separated from the web 300, the envelope 304 can drop onto a conveyor (not shown) or other means for transporting or holding the envelope 10. The loading and sealing cycle for the next envelope 304 to be produced from the web 300 can commence with the advancement of the web 300 to a position at which the cutting and sealing units 312 are aligned with the location on the web 30 at which the next transverse inter-wall seal is to be formed. This location corresponds to one of the transverse strips 40a of the heat-sealable material 34. Also, the sealer/cutters 312 are moved outwardly to their retracted positions by the actuators 314, so that the partially-formed and loaded envelope 304 can advance past the cutting and sealing units 312, and can be sealed and separated from the web 300 in the manner discussed above.

As discussed above in relation to the envelope 10, because the strips 40a of heat-sealable material 34 are applied as closely-spaced strips on one side of the sheet 33a, the transverse inter-wall seals 19a, 19b can be formed at multiple locations along the length of the web 300 by selectively activating the strips 40a only at the locations along the web 300 at which it is desired to form the inter-wall seals 19a, 19b in an envelope 304 of a particular length (while the remaining strips 40a remain un-activated), which in turn permits the length of each envelope 304 to be varied or otherwise selected by the user, as denoted by the reference characters L₁ and L₂ in FIG. 10 representing the different lengths of two envelopes 304 being produced in succession by the bagging machine 302.

The above description of the bagging machine 302 is presented for illustrative purposes only. The C-folded envelope 304, and alternative embodiments thereof, can be formed using other type of bagging machines.

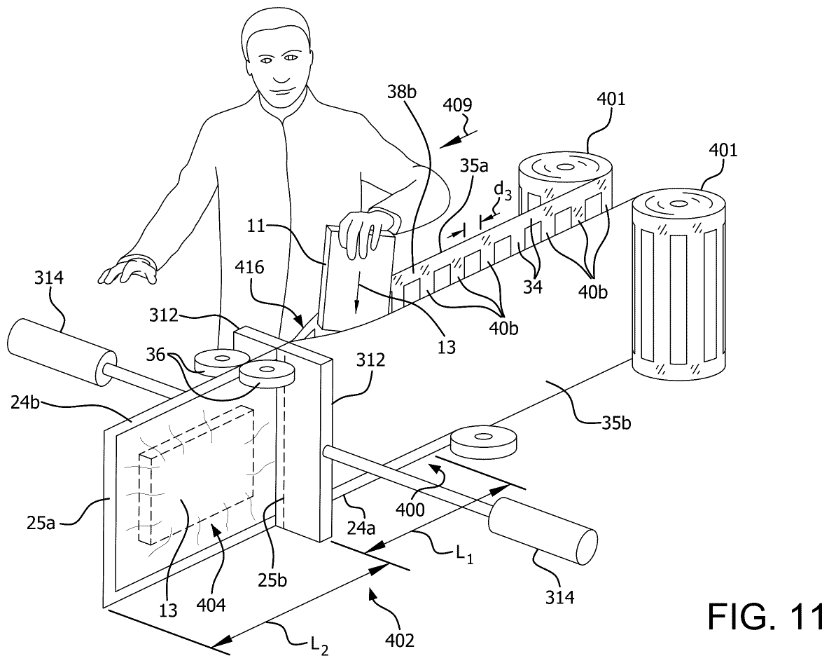

FIG. 11 depicts a bagging machine 402 configured to form an envelope 404. The envelope 404 can be formed, for example, from sheets 35a, 35b of paper or other material similar to the sheets 32a, 32b discussed above in relation to the envelope 10. As discussed above in relation to the sheets 32a, 32b, the heat-sealable material 34 can be in applied to the sheets 35a, 35b as continuous strips 38b, 40b when the envelope 402 is being formed. The strips 38b extend in a lengthwise direction, along respective side edges of the sheets 35a, 35b. As discussed below, the strips 38b, once activated by the application of heat and pressure, form inter-wall seals 24a, 24b of the envelope 404.

The strips 40b of heat-sealable material 34 are parallel, and extend transversely across the sheets 35a, 35b. Each strip 40b is spaced from its adjacent strips 40b by a common distance “d₃” so that the strips 40b are disposed in a repeating arrangement along the lengthwise direction “L” of the walls sheets 35a, 35b. For example, in some embodiments, the distance d₃ can be about 0.5 inch to about 5 inches. In other embodiments, the distance d₃ can be about 1 inch to about 4 inches. In other embodiments, the distance d₃ can be about 1 inch to about 2 inches. The spacing between the strips 40b can be non-uniform, in alternative embodiments.

The strips 40b of heat-sealable material 34 are selectively activated at the specific locations on the sheets 35a, 35b at which the inter-wall seals 25a, 25b are to be formed. Because the inter-wall seals 25a, 25b at located at the respective front and back ends of the envelope 404, the specific strips 40b that are activated to form the inter-wall seals 25a, 25b are spaced apart by the approximate length of the envelope 404, while the strips 40 located between the inter-wall seals 25a, 25b remain un-activated, thereby allowing the length of the envelope 404 to be set by the selective activation of specific strips 40b. The localized application of heat and pressure activates the heat-sealable material 34 at the specific locations at which the sheets 35a, 35b are to be fixed to each other to form the opposing walls of an envelope 404, while the remainder of the heat-sealable material 34 between those particular strips 40b remains un-activated. The walls of the newly-formed envelope 404, therefore, do not adhere to each other at locations other than the locations of the inter-wall seals 16a, 16b, 18a, 18b.

The sheets 35a, 35b can be supplied, for example, as respective rolls 401 mounted on the supply side of the bagging machine 402, as depicted in FIG. 11. The sheets 35a, 35b can be supplied in other configurations, such as a fan-folded stack, in the alternative.

The sheets 35a, 35b are drawn through the bagging machine 402 in a horizontal direction denoted by the arrow 409. The bagging machine 402 can include traction rollers (not shown) or other types of drive mechanisms that advance the sheets 35a, 35b through the bagging machine 402. The sheets 35a, 35b have a vertical orientation as they leave the respective rolls 401 and travel through the bagging machine 402. The sheets 35a, 35b are positioned so that each longitudinal edge of the sheet 35a aligns with a corresponding longitudinal edge of the sheet 35b.

The bagging machine 402 can include a first pair of heated rollers, such as the heated rollers 36 discussed above in relation to the envelope 10. As shown in FIG. 11, the lower edge portions of the sheets 35a, 35b pass between the first pair of rollers 36. The rollers 36 press the overlapping edge portions into each other, and heat the edge portions. The combination of heat and pressure on the edge portions forms longitudinal inter-wall seals 24a that partially fix the sheets 35a, 35b to each other, forming a web 400.

The bagging machine 402 also includes a sealing device, such as the cutting and sealing mechanism of the bagging machine 302 that includes the cutting and sealing units 312 and the actuators 314. Each actuator 314 is coupled to a respective cutting and sealing unit 312, and is configured to move the cutting and sealing unit 312 between an inward or extended position shown in FIG. 11, and an outward or retracted position (not shown).

After the inter-wall seal 24a is formed, the web 400, i.e., the partially joined sheets 35a, 35b, advances in the direction denoted by the arrow 409, until a location on the web 400 at which a transverse inter-wall seal is to be formed is positioned between the cutting and sealing units 312. This location can align with one of the transverse strips of heat-sealable material 34. The cutting and sealing units 312 are moved inward, to their respective extended positions, by their associated actuators 314, so that the noted location on the web 400 becomes sandwiched between the cutting and sealing units 312. The cutting and sealing units 312 apply localized pressure and heat to the web 400, which activates the underlying heat-sealable material 34 and forms the transverse seal between the sheets 35a, 35b.

At this point, as depicted in FIG. 11, a partially formed envelope 404 is bordered by the inter-wall seal 17a, and by the newly-formed transverse seal. Also, the inter-wall seal 16a, the transverse seal, and the sheets 32a, 32b define a partially-formed envelope pocket 416. An item to be packaged 11 can be inserted into the partially-formed pocket 416, from the top of the partially-formed envelope 404, as denoted by the arrow 411.

As also shown in FIG. 11, a fully-formed the envelope 404 is located at the leading end of the web 400. The bagging machine 402 also includes a second pair of heated rollers, such as the heated rollers 36 discussed above in relation to the envelope 10. The upper edge portions of the web 400 (which correspond to the upper edge portions of the sheets 35a, 35b) pass between the second pair of rollers 36 during advancement of the web 400. The rollers 36 press the overlapping edge portions together, and heat the edge portions. The combination of localized heat and pressure activates the underlying adhesive 34 and forms a longitudinal inter-wall seal 24b. The inter-wall seal 24b fixes the upper edge portions of the web 400 to each other, further enclosing and sealing the envelope pocket 316.

The cutting and sealing units 312 make a cut through the newly-formed transversely-extending seal. The cut separates the transverse seal into an first half, which forms an inter-wall seal 25a at the downstream end of the partially-formed envelope 304 that has just been loaded; and a second half, which forms an inter-wall seal 25b at the upstream end of the fully formed and loaded envelope 404 at the end of the web 400. The cut also separates the fully formed and loaded envelope 404 from the web 400. In alternative embodiments, the separation of the envelope 404 from the web 400 can be performed using techniques other than cutting, such as the focused application of heat.

Once the fully formed and loaded envelope 404 has been separated from the web 400, the envelope 404 can drop onto a conveyor (not shown) or other means for transporting or holding the envelope 404. The loading and sealing cycle for the next envelope 404 to be produced can commence with the advancement of the web 400 to a position at which the cutting and sealing units 312 are aligned with the location on the web 400 at which the next transverse inter-wall seal is to be formed. For example, the web 400 can be advanced so that the next consecutive strip 40b aligns with the cutting and sealing units 312. Alternatively, the web 400 can be advanced so that a transverse strip 40b spaced from the strip 40b activated during the previous cycle by multiple intervals, i.e., by one or more other strips 40b, aligns with the cutting and sealing units 312. Also, the sealer/cutters 312 are moved outwardly to their retracted positions by the actuators 314, so that the partially-formed and loaded envelope 404 can advance past the cutting and sealing units 312, and can be fully sealed and separated from the web 400 in the manner discussed above.

As discussed above in relation to the envelope 10, because the heat-sealable material 34 is applied in transverse strips 40b to one side of the respective sheets 35a, 35b, the transverse inter-wall seals 25a, 25b can be formed at multiple locations along the length of the web 400, which in turn permits the length of each envelope 404 to be varied or otherwise selected by the user, as denoted by the reference characters L₁ and L₂ in FIG. 11 representing the different lengths of two envelopes 404 being produced in succession by the bagging machine 402.

The above description of the bagging machine 402 is presented for illustrative purposes only. The envelope 404, and alternative embodiments thereof, can be formed using other type of bagging machines.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. An envelope for holding an item, comprising:
a first flexible wall;
a second flexible wall overlying the first flexible wall and affixed to the first flexible wall about at least a portion of a pocket border, which pocket border encloses a pocket defined at least in part by the first and second flexible walls and configured and dimensioned to contain the item, at least one of the first and second flexible walls defining a pocket opening allowing access to the pocket from an exterior of the envelope for loading the item into the pocket, the second flexible wall being affixed to the first flexible wall by a first and a second seal; and
a first, a second, and a third strip of a bonding element each extending across the first flexible wall in substantially the same direction, wherein the first seal is formed from the first strip, the second seal is formed from the second strip, and the third strip is located between the first and second strips and is un-affixed to the second flexible wall.

2. The envelope of claim 1, wherein:
the first seal is located at a first end of the envelope; and
the second seal is located at a second end of the envelope.

3. The envelope of claim 2, wherein:
the first seal is located at a top of the envelope; and
the second seal is located at a bottom of the envelope.

4. The envelope of claim 1, wherein the bonding element is a heat-activatable material.

5. The envelope of claim 4, wherein the third strip is un-activated.

6. The envelope of claim 4, wherein the heat-activatable material is a heat-sealable material or a hot-melt adhesive.

7. The envelope of claim 1, wherein the first, second, and third strips extend transversely across the first flexible wall.

8. The envelope of claim 7, wherein:
the bonding element is further configured in a longitudinal fourth strip on the first flexible wall; and
the second flexible wall is further affixed to the first flexible wall by a third seal formed from the fourth strip.

9. The envelope of claim 8, wherein the first, the second, and the third seals define at least a portion of the pocket border.

10. The envelope of claim 8, wherein the fourth strip adjoins the first, second, and third strips.

11. The envelope of claim 1, wherein the first and second flexible walls are paper.

12. The envelope of claim 1, wherein:
the bonding element is a first bonding element;
the envelope further comprises a second bonding element configured in a plurality of strips each extending across the second flexible wall;
the first seal is further formed from a first of the strips on the second flexible wall;
the second seal is further formed from a second of the strips on the second flexible wall; and
a third one of the strips on the second flexible wall is located between the first and second strips on the second flexible wall.

13. The envelope of claim 1, wherein the second seal is configured to seal the pocket opening closed after the item has been inserted into the pocket.

14. The envelope of claim 1, wherein:
the first strip is spaced from the third strip by a first distance; and
the second strip is spaced from the third strip by a second distance different than the first distance.

15. A method for forming an envelope configured to hold an item to be packaged, comprising:
providing a web having a first, a second, and a third strip of a bonding element extending across a first surface, the first surface forming a part of the web;
forming, from the first strip, a first seal between the first surface and an opposing second surface overlying the first surface;
advancing the web to align the second strip with a sealing device; and
forming, from the second strip, a second seal between the first and second surfaces; the first and second seals affixing the first surface to the second surface about at least a portion of a pocket border, which pocket border encloses a pocket defined at least in part by the first and second surfaces and configured and dimensioned to contain the item, at least one of the first and second surfaces defining a pocket opening allowing access to the pocket from an exterior of the envelope for loading the item into the pocket;
wherein advancing the web to align the second strip with the sealing device includes advancing the third strip past the sealing device without forming a seal from the third strip.

16. The method of claim 15, wherein advancing the web to align the strip with the sealing device further includes advancing the web by a distance about equal to a desired height or a desired length of the envelope.

17. A method for forming an envelope configured to hold an item to be packaged, comprising:
providing a web having a plurality of strips of a bonding element extending across a first surface, the first surface forming a part of the web;
forming, from a first of the strips of the bonding element, a first seal between the first surface and an opposing second surface overlying the first surface;
advancing the web to align the second of the strips of the bonding element with a sealing device; and
forming, from the second strip, a second seal between the first and second surfaces; the first and second seals affixing the first surface to the second surface about at least a portion of a pocket border, which pocket border encloses a pocket defined at least in part by the first and second surfaces and configured and dimensioned to contain the item, at least one of the first and second surfaces defining a pocket opening allowing access to the pocket from an exterior of the envelope for loading the item into the pocket;
wherein advancing the web to align the second strip with the sealing device includes skipping one or more of the strips of the bonding element without forming a seal therefrom.

18. The method of claim 17, wherein skipping one or more of the strips of the bonding element without forming a seal therefrom includes advancing the one or more of the strips of the bonding element past the sealing device without forming a seal therefrom.

19. A system for forming an envelope, comprising:
a web including: a first flexible wall; a second flexible wall overlying the first flexible wall and affixed to the first flexible wall about at least a portion of a pocket border that encloses a pocket defined between the first and second flexible walls and configured to contain an item; and a bonding element configured in a plurality of strips each extending across the first flexible wall; and
a bagging machine including:
a sealing device configured to heat the strips of the bonding element;
a drive mechanism configured to advance the web past the sealing device in a first direction of the web; and
a controller communicatively coupled to the drive mechanism and configured to, based on a selected dimension of the envelope in the first direction of the web, cause the drive mechanism to selectively align a first and a second one of the strips of the bonding element with the sealing device so that the first and second strips are sequentially heated by the sealing device to form respective first and second seals between the first and second flexible walls, and to advance at least one of the strips of the bonding element past the sealing device without the at least one of the strips of the bonding element being heated by the sealing device.

20. The system of claim 19, wherein the controller is configured to advance a third of the strips of the bonding element past the sealing device without the third strip being heated by the sealing device.
